(19) United States
(12) Patent Application Publication
(10) Pub. No.: US 2023/0341133 A1
(43) Pub. Date: Oct. 26, 2023

(54) MOBILE RANGE HOOD, SYSTEM AND METHOD

(71) Applicant: Vorwerk & Co. Interholding GmbH, Wuppertal (DE)

(72) Inventor: Peter Lakshmanan, Dortmund (DE)

(21) Appl. No.: 18/136,851

(22) Filed: Apr. 19, 2023

(30) Foreign Application Priority Data
Apr. 20, 2022 (EP) 22168936.7

(51) Int. Cl. F24C 15/20

(52) U.S. Cl. CPC F24C 15/2078; F24C 15/2035

(57) ABSTRACT

The present disclosure relates to a mobile range hood with a housing, a filter and a suction device, wherein the filter and suction device are arranged in the housing, wherein the housing comprises an inlet for air, wherein the suction device is configured such that the suction device can convey air from outside through the air inlet and through the filter, characterized in that the range hood is longer than high and wide and is not longer than 60 cm or not longer than 50 cm or not longer than 40 cm.

### PRIORITY CLAIM

This application claims priority to European Patent Application Serial No. 22168936.7, filed 20 Apr. 2022, which is expressly incorporated by reference herein.

### FIELD OF THE DISCLOSURE

The present disclosure relates to a mobile range hood (kitchen hood, extractor hood) with a housing, a filter and a suction device. The filter and the suction device are arranged in the housing. The housing comprises a grid. The suction device is configured such that the suction device can suck air from outside through the grid and through the filter. The present disclosure also relates to a system and method.

### BACKGROUND

In a kitchen, fumes (steams, vapors) are produced when food is cooked and fried. To prevent odors and grease deposits associated with the fumes, range hoods are provided. Through a range hood, the fumes generated by cooking and frying are extracted by means of the suction device and through the filter. Grease deposits, odors and/or moisture can thus be avoided or at least reduced in a kitchen.

There are stationary cooktops mounted in kitchens for cooking and frying food in pots and pans. Above such cooktops, range hoods may be stationary mounted on a wall or kitchen cabinet. The size of such a range hood is basically adapted to the dimensions of a cooktop. A stationary mounted range hood cannot be detached and used in another place without tools.

In a kitchen, there may be not only stationary mounted cooktops for cooking and frying food, but additionally mobile food preparation apparatuses such as food processors with a heatable food preparation vessel. Such a mobile food preparation apparatus can be set up flexibly in a kitchen, since it is not fastened to a wall or a cabinet, for example. The set-up location can therefore be easily changed at any time. The use of tools is not necessary for this.

Since mobile food preparation apparatuses provided for heating food are to be placed outside of cooktops, a stationary mounted range hood does not or only insufficiently capture fumes from mobile food preparation apparatuses.

### SUMMARY

It is the task of the present disclosure to prevent odors, grease deposits and/or moisture that may arise due to the operation of a mobile food preparation apparatus in an improved manner.

The task is solved by a range hood with the features of the first claim. Advantageous embodiments result from the dependent claims. A system comprises the features of the first additional claim for solving the task. A method comprises the features of the second additional claim for solving the task.

To solve the task, a mobile range hood comprises a housing, a filter and a suction device. Filter and suction device are arranged in the housing. The housing has an inlet for air. The suction device is configured such that the suction device is capable to allow air to flow from the outside through the air inlet and through the filter. The range hood may be longer than high and wide. The range hood may be no longer than 60 cm, preferably no longer than 50 cm, particularly preferably no longer than 40 cm.

### BRIEF DESCRIPTIONS OF THE FIGURES

The present disclosure is explained in more detail below by means of figures. The figures show:

FIG. 1: range hood;

FIG. 2: food processor;

FIG. 3: food processor with attached range hood;

FIG. 4: food processor with attached range hood;

FIG. 5: food processor with attached range hood;

FIG. 6: end face of a range hood with stand;

FIG. 7: range hood set up on stand;

FIG. 8: range hood with slide-in compartment;

FIG. 9: sectional view through range hood;

FIG. 10: range hood with stand.

### DETAILED DESCRIPTION

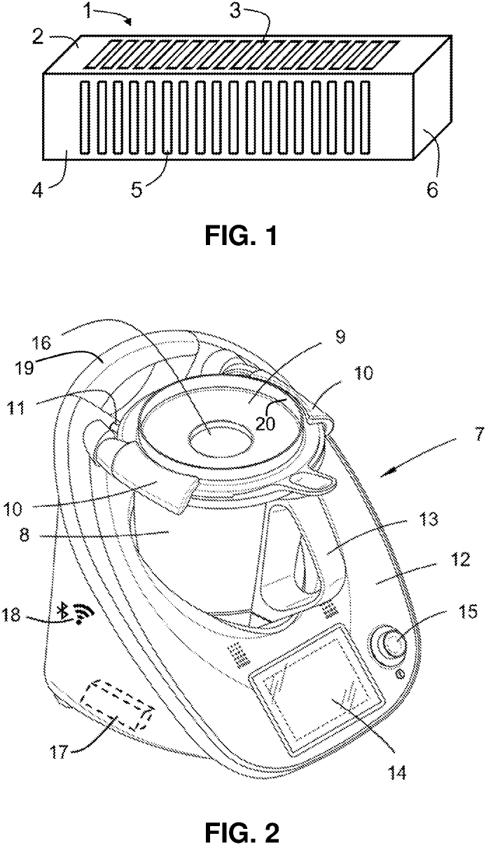

The FIG. 1 shows a mobile range hood 1. The housing of the range hood 1 has a wall 2 with an air outlet in the form of a grid 3. Air sucked in by the range hood 1 can thus leave the range hood 1 through the grid 3. A wall 4 of the housing has an air inlet in the form of a grid 5. Air sucked in by the range hood 1 can enter the housing of the range hood 1 through the grid 5. The walls 2 and 4 are adjacent to each other. The walls 2 and 4 enclose at least approximately a right angle.

The range hood 1 has two opposing end faces 6. The end faces 6 may be square or at least approximately square. Then the height of an end face 6 corresponds to the width of the end face 6. With the exception of the walls 2 and 4, the walls of the housing have no openings through which air can pass. Thus, the walls without openings are airtight. The length of the range hood 1 is much greater than the height and width of the range hood 1. The range hood 1 can be approximately 20 cm to 30 cm long. The range hood 1 can be approx. 6 cm to 12 cm high. The range hood 1 can be approx. 6 cm to 12 cm wide.

Inside the housing of the range hood 1 there is a suction device, namely a fan (blower), a filter, a regulating unit with which the operation of the fan can be regulated, and a radio unit. An on/off switch may be attached to the housing of the range hood. A rechargeable battery is provided in the range hood 1, with which the range hood 1 can be operated independently of an external power source.

The range hood 1 is small and compact. The range hood 1 is not intended and suitable to be permanently, i.e. stationary, non-detachably fastened to a wall or cabinet. Instead, the range hood 1 can be placed flexibly. The range hood is therefore a mobile range hood.

FIG. 2 shows a food processor 7 with a food preparation vessel 8. A lid part 9 is placed on the food preparation vessel 8. The lid part 9 for the food preparation vessel 8 is locked by arms 10. The lid part 9 is located between the two arms 10. The arms 10 can be rotated about their longitudinal axis by a motor of the food processor, and thus back and forth between an open position and a locked position. The lid part 9 has pressed down and thus released a sensor, namely a rocker arm 11 of an electric switch. The arms 10 and the rocker arm 11 are attached to a stand part 12 of the food processor 7. The food preparation vessel 8 is inserted into the stand part 12 and can be removed from the stand part 12. In order to be able to remove the food preparation vessel 8, this comprises a handle 13. For operation, the stand part 12 comprises a touch-sensitive display 14 and a rotary switch 15. The rotary switch 15 can be rotated and pressed. The display 14 and rotary switch 15 are thus operating elements of the food processor 7. Data can be entered via the operating elements 14 and 15. The lid part 9 comprises an opening 16 in the center which can be closed with a closure not shown, for example a vessel-like closure.

A control device 17 is located in the stand part 12. A radio unit 18 is located in the stand part 12, via which data can be sent and received wirelessly. The radio unit 18 can send and receive data via Bluetooth and/or WIFI, for example. The control device 17 can, for example, access an externally electronically stored recipe via the radio unit 18. The control device 17 can control the preparation of a food by means of the recipe. Via the radio unit 18, the control device 17 can exchange data wirelessly with the range hood 1, i.e. communicate. However, alternatively or complementarily, recipes can also be stored in a memory unit of the control device. The control device 17 can control the operation of the range hood 1.

In the food preparation vessel 8 there is a cutting tool which can be driven by a motor. The motor is located in the stand part 12. In the bottom of the food preparation vessel 8 there is a heating device which can be connected to the stand part 12 in an electrically conducting manner for heating. The motor for rotating the arms 10 is also arranged in the stand part.

The stand part 12 has a handle 19 on its upper side. The range hood 1 can be fastened to the handle 19, for example, by means of a clamp of the range hood. The cover part 9 has an upwardly projecting, annular collar 20. The range hood 1 can be fastened to the collar 20, for example, by means of a clamp of the range hood. In both cases, the range hood is located directly at the area where fume can escape from the food preparation vessel 8.

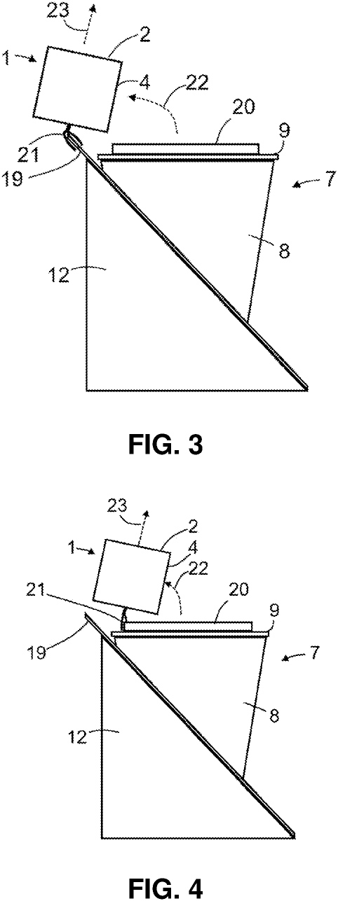

FIG. 3 shows a side view of the food processor 7 with the range hood 1 attached to it. The range hood 1 is fastened to the handle 19 of the stand part 12 of the food processor 7 by means of a clamp 21. The clamp 21 can be pivotably connected to the housing of the range hood 1. The clamp 21 is fastened to the underside of the range hood 1. The wall 4 with the air inlet of the range hood 1 is inclined towards the lid part 9 of the food preparation vessel 8. During preparation of a food, fume 22 exiting from the food preparation vessel 8 can be sucked in by the range hood 1. Purified air 23 is blown upward out of the range hood 1. This avoids that a possibly existing rear kitchen wall or wall of a kitchen cabinet is directly exposed to the escaping air flow. The rear side is also available for a fastening device with which the range hood 1 can be detachably fastened to a wall.

FIG. 4 shows the attachment of the range hood 1 to the collar 20 of the cover part 9. The clamp 21 then clasps the collar 20.

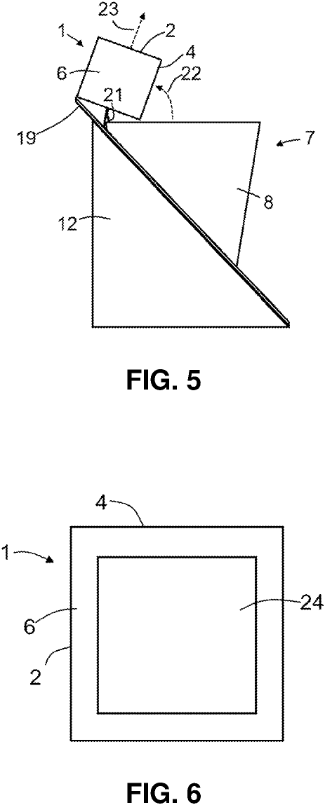

FIG. 5 shows the attachment of the range hood 1 to the food preparation vessel 8. The clamp 21 then clasps the upper edge of the food preparation vessel 8.

FIG. 6 shows a view of an end face 6 of an embodiment of the range hood 1. At this end face 6, a stand 24 is integrated which can be extended (pulled out) of the end face 6. The stand can be moved back and forth, for example, between an initial position and an end position. The stand 24 can permanently protrude from the end face so that it can be gripped and moved. The stand then also protrudes from the end face 6 in the initial position. It is possible that, for example, by means of a latching mechanism, a clamping mechanism or by means of magnetic forces, the stand 24 can be fixed in a freely selectable position between the initial position and the end position. It is possible that, for example, by means of a latching mechanism or magnetic forces, the stand 24 can be fixed in steps between the initial position and the end position.

It is possible that the underside of the stand 24 is flush with the surface of the end face 6 when the stand 24 has been brought into its initial position. For example, by tapping the stand 24, the stand 24 can be moved, for example by means of a preloaded spring, into an extended position, for example into its end position. Through tapping, a holding mechanism is then deactivated. When the stand 24 is pushed from the initial position to the initial position against the force of the biased spring, for example, the holding mechanism is activated and the stand is held in the initial position.

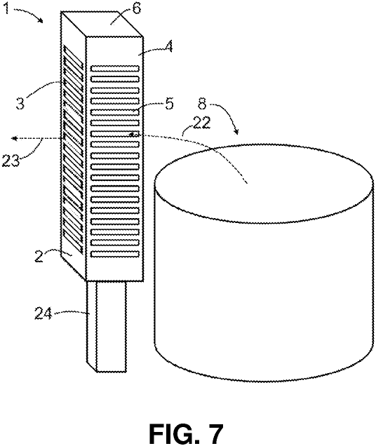

In FIG. 7, the range hood 1 of FIG. 6 is shown in the upright set up condition. The stand 24 has been moved to an extended position. The extended position may be the end position. The stand 24 stands on a base next to a food preparation vessel 8. Fume 22 from the food preparation vessel 8 can now be sucked into the range hood 1 through the grid 5 in an optimized manner. Air 23 can be blown out of the range hood 1 in purified form through the grid 3.

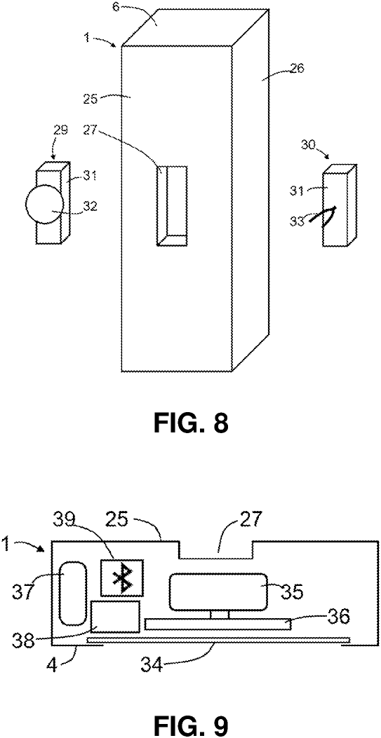

In FIG. 8, an embodiment of a range hood is shown from the rear side compared to the illustrations in FIGS. 1 and 7. Wall 25 is opposite wall 4 shown in FIGS. 1 and 7. Wall 26 is opposite wall 2 shown in FIGS. 1 and 7. Walls 25 and 26 are closed in an airtight manner. Wall 25 comprises a slide-in compartment 27. The fastening device 29 or the fastening device 30, selectively, can be slid into this slide-in compartment 27. The fastening device 29 has a base part 21 and a suction cup 32. The fastening device 30 has a base part 21 and a clamp 33. Each base part 31 is adapted to the slide-in compartment such that each base part 31 can be slid into the slide-in compartment 27. There may be a retaining mechanism that may retain a base part 31 in the slide-in compartment 27. A latch mechanism may form the retention mechanism. A hook and loop fastener is possible by which a base part may be retained in the slide-in compartment. A base part 31 may alternatively or supplementally be magnetically retained in the slide-in compartment 27.

Instead of a slide-in compartment, another mechanism may be provided on the wall 25 and/or the wall 26 to allow fastening devices 29, 30 to be attached and easily replaced. The other mechanism may comprise, for example, a rail with a latching mechanism. The fastening devices 29, 30 may comprise corresponding positive locking elements by which each fastening device may be moved along a rail for fastening until the locking mechanism engages. The latching mechanism can then be unlatched again to allow replacement of a fastening device.

The other mechanism can be realized by magnetic connections.

FIG. 9 sketches a sectional view of a range hood 1 with a filter 34 behind the inlet opening. Behind the filter 34 there is a fan with an impeller 36 and an electric motor 35 connected thereto. Also arranged within the housing of the range hood 1 are a battery 37, a radio unit 39 and a regulating unit 38. The radio unit 39 may be a Bluetooth radio unit.

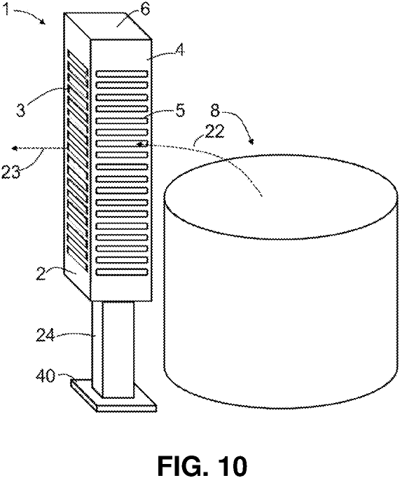

In FIG. 10, a range hood 1 is shown with a stand 24 that comprises a plate 40 on its underside to improve stability. The plate 40 may consist of metal to further improve stability. The length and width of the plate 40 may correspond to the length and width of the end face. For example, the stand 24 may be moved toward the end face 6 until the plate 40 contacts the end face 6. It may then be possible to grasp the plate 40 to extend the stand again.

It is possible that the end face 6 includes a slide-in compartment into which one end of the stand can be detachably slid. The stand can then be completely detached from the range hood housing, for example, and stored separately.

The housing is a shell protecting the filter and the suction device. The housing may therefore consist of a solid material such as metal and/or a plastic. The housing contributes to the control of an air flow. There is therefore an inlet for air and an outlet for air in the housing. The inlet and/or the outlet may be protected from reaching through by a grid or a screen.

The filter is a device that retains components from an air stream as the air passes through the filter. In particular, the filter may retain grease, oil, and/or steam. The filter may comprise one or more filter elements. Filter elements may be arranged in series as viewed in the direction of flow. Air may then flow through a first filter element, then a second, and so on. Filter elements of a filter can be different.

The suction device can generate an air flow. The suction device may comprise an impeller driven by a motor. The impeller may be a wheel with blades fastened to it. The airflow is generated by rotating the impeller. The motor may be an electric motor. The suction device may comprise a regulating unit to regulate (control) the speed of the electric motor.

The dimensions of the range hood may be such that the range hood can be set up, for example, upright next to a food preparation vessel without requiring an excessively large footprint. The range hood may therefore be suitably and flexibly used in a kitchen without being perceived as unduly obtrusive.

The range hood may comprise a fastening device by means of which the range hood can be detachably fastened the to a food preparation vessel, to a food preparation apparatus or to a wall. Thus, the range hood can be used in a kitchen in a flexible manner to extract fume from a food preparation vessel in a further improved manner.

The fastening device may be or comprise a clamp or a suction cup.

A clamp detachably or non-detachably attached to the range hood can be detachably fastened to a rim of a food preparation vessel, for example. The range hood can then be arranged immediately adjacent to the exit region of fume. The range hood can then extract fume in an optimized manner. The food preparation vessel may be a cooking pot or pan. The food preparation vessel may be part of a food processor.

A clamp detachably or non-detachably attached to the range hood can be detachably fastened, for example, to an upwardly protruding collar or web of a lid portion of a food preparation vessel. The range hood can then be arranged immediately adjacent to the exit region of fume. The range hood can then extract fume in an optimized manner.

A clamp detachably or non-detachably attached to the range hood can be detachably fastened to a handle of a food preparation apparatus, for example. This is particularly true if the handle is located near a fume exit area of the food preparation apparatus. The handle may be a handle of a stand part of a food processor. A food processor comprises a food preparation vessel that can be inserted into the stand part.

By detachably, it is meant that a connection can be detached non-destructively without the use of tools. A non-detachable connection is when the connection can only be detached by destroying the connection, or when tools must be used to detach the connection.

A suction cup detachably or non-detachably attached to the range hood can be detachably fastened to a smooth surface, such as tiles on a wall. This also helps to arrange the range hood flexibly and appropriately in a kitchen without the range hood interfering excessively.

The fastening device may comprise a hook, a latching mechanism and/or a magnet for being able to detachably attach the range hood suitably and flexibly in a kitchen in the vicinity of a fume exit area. A fastening device may be such that it can be attached to a food preparation apparatus by one or more positive-locking elements (form-fitting elements). For example, a positive-locking element may be inserted into a hole of a food preparation apparatus to create a connection that helps attach the range hood to the food preparation apparatus in a desired position. A positive-locking element may then also be frictionally held.

The range hood may comprise a magnetizable metal plate, which may therefore be magnetically held. For example, the metal plate consists of ferromagnetic material. If, for example, a food preparation apparatus comprises a magnet suitably arranged therefor, then the range hood may be held to the food preparation apparatus by this magnet.

A fastening device may comprise a clamp, a suction cup, a magnet, and/or a hook by which the fastening device can be detachably attached to the range hood. A fastening device may comprise a thread with which the fastening device can be attached to the range hood.

The range hood may comprise a slide-in compartment for a fastening device. Various fastening devices can be present, which can be selectively inserted into the slide-in compartment in order to be able to use a fastening device suitable for the respective requirement, depending on the need. A fastening device may be protected in the slide-in compartment from falling out unintentionally, for example, by a detachable latching mechanism or by means of a magnetic connection. Different fastening devices may optionally be fastened to the housing of the range hood in another way, for example by a detachable snap connection and thus by a form-fit connection. A bayonet lock is also possible in order to be able to connect a fastening device interchangeably to the housing of the range hood.

A fastening device may be integrally bonded to the fastening device and thus non-detachably attached.

The fastening device may be pivotally and/or rotatably attached to the housing of the range hood. Following fastening of the range hood, the range hood can then be pivoted and/or rotated. This allows the range hood to be aligned following its fastening to extract interfering fume in a further improved manner.

The fastening device may be fastened to an airtight housing wall of the range hood. The fastening device is thus shielded from sucked-in fume. Contamination of the fastening device and an associated impairment can thus be avoided.

The wall opposite the housing wall with the fastening device fastened thereto may comprise an air outlet or an air inlet. The fastening device may be shielded from a fume-containing air flow in a further improved manner due to its distance from the air outlet and/or air inlet. Contamination of the fastening device and associated impairment may be avoided in a further improved manner.

Further walls of the range hood may comprise an air inlet or an air outlet.

One wall of the range hood may comprise an air inlet and an adjacent wall may comprise an air outlet. The two walls may include an angle of 40° to 140°, for example. It is then possible to extract fume laterally and, after passing through the filter, to blow out the associated air upward. A very good effect can be achieved in this way. An air stream blown out upwards is perceived as little disturbing.

One or both end faces of the housing of the range hood can be airtight. Since these then do not comprise an air inlet or air outlet, the end faces can then be used advantageously as a footprint to enable the range hood to be set up upright (on edge) and thus in a particularly suitable manner.

The range hood may be at least twice as long as it is high and/or at least twice as long as it is wide. For example, the range hood can be about three times as long as it is high and/or about three times as long as it is wide. Elongated surfaces are then available for air inlet and/or air outlet, in order to be able to extract fume in a particularly suitable manner.

The range hood may be a maximum of 30 cm, preferably a maximum of 20 cm or a maximum of 15 cm wide. The range hood may be a maximum of 30 cm, preferably a maximum of 20 cm or a maximum of 15 cm high. The range hood can then be handled particularly easily and can also be stored unproblematically in a kitchen drawer.

The range hood may comprise an extendable stand. The stand can then be moved back and forth between an initial position and an end position. The height of a range hood set up on the stand can then be adjusted to extract fume in an optimized manner. There may be a latching mechanism or clamping mechanism to allow the stand to be held in an extended desired position such that the range hood can be placed at a desired height. For example, the stand may be held in the end position by a biased spring.

The stand may be arranged at an end face of the range hood. The range hood can then advantageously be set up upright and also the height can be adjusted to optimize the fume extraction effect. The stand can also be arranged on a side wall of the range hood. The range hood can then, for example, be set up horizontally by means of the stand and, if necessary, also at a desired height.

The range hood can comprise a holder for being able to suitably set up the range hood. The holder can be non-detachably or detachably connected to the housing of the range hood.

The range hood may comprise a humidity sensor, a temperature sensor, a pressure sensor, a gas sensor, and/or a distance sensor. Such sensors can be used to optimize the operation of the range hood.

Fume may be accompanied by increased humidity. Therefore, unwanted fume can be detected by a humidity sensor. Depending on this, the operation of the range hood can be controlled. Thus, the range hood can be switched on and/or off in an automated manner when fume is detected due to increased humidity. The power of the suction device can be controlled as a function of the detected humidity and thus as a function of the demand for extracting fume. As the detected moisture increases, the power of the suction device can be increased in an automated manner. The range hood can be configured accordingly.

Fume may be accompanied by increased temperature. Therefore, unwanted fume can be detected by a temperature sensor. Depending on this, the operation of the range hood can be controlled. Thus, the range hood can be switched on and/or off in an automated manner when fume is detected due to elevated temperature. The power of the suction device can be controlled as a function of the detected temperature and thus as a function of the demand for extracting fume. As the detected temperature increases, the power of the suction device can be increased in an automated manner. The range hood can be configured accordingly.

Fume may be accompanied by a gas composition that deviates from normal air. Therefore, unwanted fume can be detected by a gas sensor. Depending on this, the operation of the range hood can be controlled. Thus, the range hood can be switched on and/or off in an automated manner when fume is detected by a gas sensor. The power of the suction device can be controlled as a function of the detected gas composition and thus as a function of the demand for extracting fume. As the detected deviation from usual air increases, the power of the suction device can be increased in an automated manner. The range hood can be configured accordingly.

A distance sensor can be used to detect the distance to a food preparation vessel from which fume may escape. The power of the suction device can be controlled as a function of a detected distance and thus as a function of the demand for extracting fume. As the detected distance increases, the power of the suction device can be increased in an automated manner. The range hood can be configured accordingly. A distance sensor can be realized by lidar. A camera can serve as a distance sensor. Distance measurement can be implemented by means of NFC.

A distance can be determined by evaluating the strength of a radio signal. The range hood may send a radio signal to a food preparation apparatus. The food preparation apparatus may evaluate the signal strength and thus determine the distance. A distance can be determined, for example, by means of stored reference values by the food preparation apparatus. The reference values may be stored in the food preparation apparatus or in the range hood.

The food preparation apparatus may be arranged and configured such that it can control the operation of the range hood. The food preparation apparatus may be adapted to switch the range hood on and off. The food preparation apparatus may be adapted to adjust the power of the suction device, such as a motor speed of a fan of the range hood. The food preparation apparatus may be adapted to set a large power of the suction device of the range hood when a large distance between the food preparation apparatus and the range hood is detected, and a small power in comparison when a small distance is detected.

A pressure sensor may be used to detect pressure losses of air flowing through the range hood. For example, the condition of the filter can be detected in order to signal the need for replacement of the filter or a filter element, for example visually and/or acoustically.

Thus, the range hood may be configured such that operation of the range hood and/or maintenance thereof may be controlled in dependence on one or more measured values from one or more sensors.

The range hood may comprise a radio unit for wireless transmission and/or reception of data. For example, Wi-Fi, Bluetooth, Thread, z-Wave, and/or ZigBee may be provided as the radio protocol. Via the radio unit, the operation of the range hood can be controlled, for example, by an external device. Via the radio unit, data of the range hood or information about the range hood can be sent, for example, to an external device. For example, maintenance information and/or status information may be sent to an external device. For example, information can be sent as soon as the filter or a filter element of the filter is to be replaced. For example, information can be sent about a pressure loss caused by the filter. For example, information can be sent about a possible remaining service life of the filter, which can be estimated, for example, on the basis of the determined pressure loss and/or on the basis of the engine running time since the last filter change.

A pressure loss can be measured directly by a pressure sensor. However, a pressure loss can also be determined indirectly from current, voltage and motor speed of the suction device.

The external device may be a cell phone with software installed on it provided for the range hood. The external device may be a food preparation apparatus such as a food processor.

The food preparation apparatus may be configured such that it can prepare a food in an at least partially automated manner by means of an electronically stored recipe. The recipe may comprise a control for the range hood. The range hood may be adjusted in the manner specified by the recipe during preparation of a food. The adjustment may be performed in an automated manner or manually.

The operation of the range hood may be controlled dependent on time. For example, if a food is prepared by recipe in a partially automated manner, then the range hood can be operated in a time-dependent manner from the beginning of the partially automated preparation. The range hood can therefore be switched on and/or off in a time-controlled manner. The power of the range hood can be set on a time-controlled basis.

The range hood may comprise a battery in order to be operated independently of a stationary mounted power source.

The power of the suction device may be adjustable, for example, in several levels manually and/or in an automated manner. For example, two, three, or four levels may be adjustable. For example, the power of the suction device may be continuously adjustable manually and/or in an automated manner. The range hood may comprise an input device with which a speed of the suction device can be set manually.

The filter may be or comprise an expanded-metal filter. The filter may be such that its grease removal efficiency is greater than 75%. The grease removal efficiency may be close to 100%, such as 98%.

The filter may be or comprise a paper filter. The paper must be replaced after saturation.

The filter may be or comprise a nonwoven (fleece) filter. The nonwoven filter may consist of a layer of fleece a few millimeters thick. A nonwoven filter must be replaced after its saturation.

The filter may be or comprise a labyrinth filter. In the labyrinth filter, the air flow is meandered around suitably formed elements. The grease or oil then separates on the surfaces of the elements. A labyrinth filter may comprise one or more troughs in which separated oil or grease may collect.

The filter may include a filter bed, i.e., a particulate solid, particularly one having a large internal surface area. The filter may include one or more filter elements, which may have channels extending therethrough. The filter may include a depth filter and/or a surface filter. The filter may include a solid body, optionally porous, which may include flow channels.

Preferably, the area of the filter is at least as large as the inlet area of the air inlet. The filter is located downstream of the air inlet, as viewed in the direction of flow. The filter is preferably adjacent to the air inlet. The filter may be adjacent to a grid or screen of the air inlet.

The present disclosure also relates to a system comprising a range hood and a food preparation apparatus. The range hood may be detachably fastened to the food preparation apparatus. The range hood may be as previously described.

The food preparation apparatus and the range hood may be configured such that operation of the range hood may be controlled by the food preparation apparatus. The food preparation apparatus may be a food processor. By food processor is meant a food preparation apparatus comprising a stand part and a food preparation vessel insertable into a receptacle of the stand part. There is a mixing and/or chopping tool by means of which food in the food preparation vessel can be mixed and/or chopped. The food processor comprises a heating device by means of which food can be heated in the food preparation vessel.

The food preparation apparatus may be configured such that the food preparation apparatus can access an electronically stored recipe. For example, the food preparation apparatus may control the range hood in dependence on the electronically stored recipe. For example, the recipe may comprise information for controlling the range hood, which then cause the food preparation apparatus to control the range hood according to this information.

The present disclosure also relates to a method for preparing a food, according to which a range hood is detachably attached to a food preparation apparatus. After the detachable attachment, a food is prepared by the food preparation apparatus by heating. If required, the range hood can then be put into operation in an automated manner or manually. For example, after the food is prepared, the range hood can be detached from the food preparation apparatus.

1. A mobile range hood comprising a housing,
a filter, and
a suction device,
wherein filter and suction device are arranged in the housing, wherein the housing comprises an inlet for air, wherein the suction device is configured such that the suction device can convey air from outside through the air inlet and through the filter, and wherein the range hood is longer than high and wide and is not longer than 60 cm.

2. The mobile range hood of claim 1, wherein the range hood comprises a fastening device by means of which the range hood can be detachably fastened to a food preparation vessel, to a food preparation apparatus or to a wall.

3. The mobile range hood of claim 2, wherein the fastening device comprises a clamp or a suction cup.

4. The mobile range hood of claim 2, wherein the fastening device is pivotally and/or rotatably fastened to the housing of the range hood.

5. The mobile range hood of claim 2, wherein the fastening device is fastened to an airtight housing wall of the range hood.

6. The mobile range hood of claim 5, wherein the wall opposite the housing wall with the fastening device fastened thereto comprises a grid or a screen.

7. The mobile range hood of claim 1, wherein two adjacent walls of the range hood each comprise a grid (3, 5) or a screen.

8. The mobile range hood of claim 1, wherein range hood is at least twice as long as high and/or at least twice as long as wide.

9. The mobile range hood of claim 1, wherein the range hood comprises an extendable stand (24).

10. The mobile range hood of claim 1, wherein the stand (24) is arranged at an end face (6) of the range hood.

11. The mobile range hood of claim 1, wherein the range hood comprises a humidity sensor, a temperature sensor, a pressure sensor, a gas sensor and/or a distance sensor.

12. The mobile range hood of claim 11, wherein the range hood is configured such that the operation of the range hood can be controlled in dependence on a measured value of a sensor.

13. A system comprising
a mobile range hood including a housing, a filter and a suction device, wherein filter and suction device are arranged in the housing, wherein the housing comprises an inlet for air, wherein the suction device is configured such that the suction device can convey air from outside through the air inlet and through the filter, and wherein the range hood is longer than high and wide and is not longer than 60 cm and
a food preparation apparatus,
wherein the food preparation apparatus and the range hood are configured such that the operation of the range hood is controlled by the food preparation apparatus.

14. The system of claim 13, wherein the food preparation apparatus is configured such that the food preparation apparatus can access an electronically stored recipe and that the food preparation apparatus controls the range hood in dependence on the electronically stored recipe.

15. A method for preparing a food, the method comprising
providing a user-detachable range hood, the range hood including a housing, a filter and a suction device, wherein filter and suction device are arranged in the housing, wherein the housing comprises an inlet for air, wherein the suction device is configured such that the suction device can convey air from outside through the air inlet and through the filter, and wherein the range hood is longer than high and wide and is not longer than 60 cm
attaching the a range hoodto a food preparation apparatus, and
after the attachment step, preparing a food is in the food preparation apparatus through heating.
